(19) United States
(12) Patent Application Publication
(10) Pub. No.: US 2016/0031395 A1
(43) Pub. Date: Feb. 4, 2016

(54) REINFORCEMENT STRUCTURE FOR ENGINE HOOD OF MOTOR VEHICLE

(71) Applicant: GIZMO PLASTICS TECH. INC., Kaohsiung City (TW)

(72) Inventor: Chun-Lung HUANG, Kaohsiung City (TW)

(21) Appl. No.: 14/448,315

(22) Filed: Jul. 31, 2014

(51) Int. Cl. B60R 19/52; B60K 11/08; B62D 25/12

(52) U.S. Cl. CPC B60R 19/52; B62D 25/12; B60K 11/08; B60R 2019/525

(57) ABSTRACT

A reinforcement structure includes an air inlet chamber, an air outlet chamber and at least one air outlet channel. The air outlet channel is formed by an outer cover plate, an inner cover plate, and two side plates respectively connected to the outer cover plate and the inner cover plate. A plurality of ribs are inwardly extended at inner sides of the air inlet chamber and the air outlet chamber, and an arched guiding angle is formed between any two adjacent ribs. A reinforcement plate is extended from the outer cover plate to form an included angle with the outer cover plate. A connecting plate is disposed at an end of the reinforcement plate and is parallel with the outer cover plate. A distance between the connecting plate and the outer cover plate is smaller than that between the connecting plate and the inner cover plate.

### BACKGROUND OF THE INVENTION

a) Field of the Invention

The invention relates in general to a reinforcement structure for an engine hood of a motor vehicle, and more particularly to a reinforcement structure for reinforcing the structural strength of an engine hood of a motor vehicle.

b) Description of the Related Art

Referring to FIG. 1 to FIG. 4, a conventional engine hood A of a motor vehicle mainly includes an air inlet chamber A1 and an air outlet chamber A2. The air inlet chamber A1 has an air inlet A3 at a lateral side to guide air into the air inlet chamber A1. The air then passes an air filter B to filter out suspended particles to prevent damages on an engine.

As the engine hood A of the motor vehicle is in long-term exposed to and unprotected from exterior environments, the engine hood A is liable to impacts of external forces. The Taiwan Patent No. M308846 of the Applicant, dated Jul. 31, 2006, discloses “Housing Reinforcement Structure”. The structure of the above disclosure is applied to within the air inlet chamber A1 and the air outlet chamber A2 of the engine hood A of the motor vehicle, in a way that a plurality of ribs C are formed at inner sides of surfaces of the air inlet chamber A1 and the air outlet chamber A2 of the engine hood A of the motor vehicle.

These ribs C are vertically and horizontally staggered in a beehive arrangement at the inner sides of the surfaces of the air inlet chamber A1 and the air outlet chamber A2, thereby enhancing the overall strength of the housing of the engine hood A of the motor vehicle.

As shown in FIG. 2 and FIG. 3, the ribs C are vertically and horizontally staggered in a hexagonal beehive arrangement. Thus, an included angle θ of 120° is formed at a junction of adjacent edges of every two ribs. However, the included angle θ likely causes concentrated stress during an injection and molding process of the engine hood A of the motor vehicle, resulting in breakage or improper filling at the included angle θ.

Although the Applicant provided the reinforcement structure for the air inlet chamber A1 and the air outlet chamber A2 of the engine hood A of the motor vehicle, it is discovered through long-term use that the strength of an air outlet channel A4 between the air inlet chamber A1 and the air outlet chamber A2 of the engine hood A of the motor vehicle is inadequate. In the industrial field, a solution of using only an extension plate A7 that is extended between an outer cover plate A5 and an inner cover plate A6 is usually applied.

However, such extension plate A7 is incapable of effectively enhancing the structural strength of the outer cover plate A5 of the air outlet channel A3. When receiving impacts of external forces, damages at the engine hood A of the motor vehicle and the outer cover A5 are frequently resulted, leading to a reduced life cycle of the engine hood A of the motor vehicle,

Therefore, the present invention aims to provide a solution for enhancing the structural strength of the engine hood of the motor vehicle.

### SUMMARY OF THE INVENTION

To achieve the above object, an engine hood of a motor vehicle includes an air inlet chamber, an air outlet chamber, and at least one air outlet channel. The air outlet channel, disposed between the air inlet chamber and the air outlet chamber, is formed by an outer cover plate, an inner cover plate, at two side plates connected to respective lateral sides of the outer cover plate and the inner cover plate. The engine hood is characterized that, a plurality of ribs are inwardly extended at inner sides of surfaces of the air inlet chamber and the air outlet chamber, the ribs are vertically and horizontally staggered in a polygonal arrangement at the inner sides of the surfaces of the air inlet chamber and the air outlet chamber, and an arched guiding angle is formed between any two adjacent ribs. At least one reinforcement plate is extended from above the outer cover plate towards the inner cover plate. An included angle is formed between each reinforcement plate and the outer cover plate. A connecting plate is disposed at an end of the reinforcement plate, and is parallel with the outer cover plate. Further, a distance between the connecting plate and the outer cover plate is smaller than a distance between the connecting plate and the inner cover plate.

Accordingly, the strength of the outer cover plate of the air outlet channel near the exterior side of the engine hood of the motor vehicle is reinforced through with reinforcement plate and the connecting plate. Thus, the outer cover plate is prevented from damages caused by impacts of external forces to further enhance the overall strength of the engine hood of the motor vehicle.

Further, a strengthening plate is provided between the connecting plate and the inner cover plate. Two ends of the strengthening plates are respectively connected to the connecting plate and the inner cover plate.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a schematic diagram of a conventional engine hood of a motor vehicle;

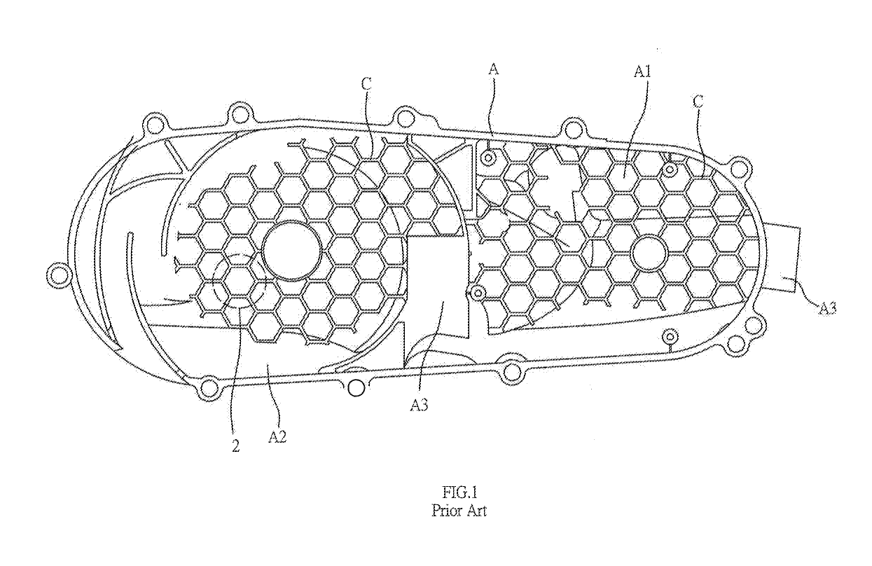

FIG. 2 is an enlarged view of ribs on a conventional engine hood of a motor vehicle;

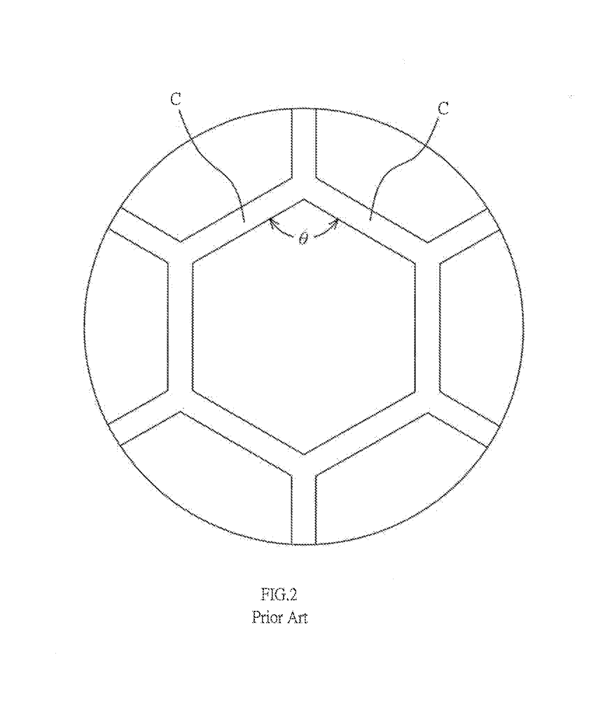

FIG. 3 is a sectional view of a conventional engine hood of a motor vehicle added with an air filter;

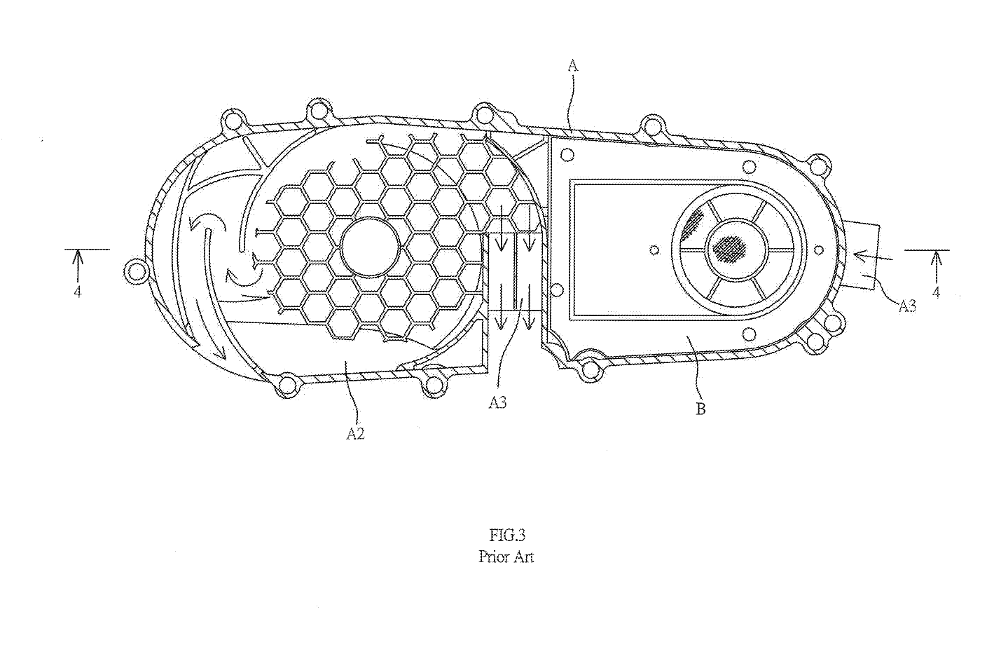

FIG. 4 is a sectional view of FIG. 3;

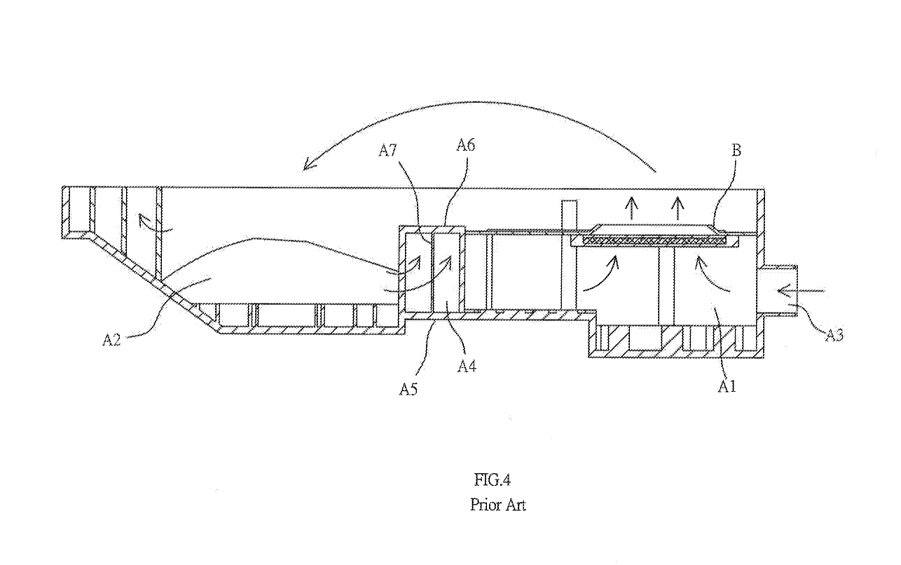

FIG. 5 is a schematic diagram of an engine hood of a motor vehicle added with an air filter according to an embodiment of the present invention;

FIG. 6 is an enlarged view of ribs according to an embodiment of the present invention;

FIG. 7 is an enlarged view of an air outlet channel from a first angle according to an embodiment of the present invention;

FIG. 8 is a sectional view of an engine hood of a motor vehicle according to an embodiment of the present invention;

FIG. 9 is an enlarged view of an air outlet channel from a second angle according to an embodiment of the present invention;

FIG. 10 is a sectional view an engine hood of a motor vehicle according to a second embodiment of the present invention;

FIG. 11 is an enlarged view of an air outlet channel according to the second embodiment of the present invention;

FIG. 12 is a sectional view an engine hood of a motor vehicle according to a third embodiment of the present invention;

FIG. 13 is an enlarged view of an air outlet channel according to the third embodiment of the present invention.

### DETAILED DESCRIPTION OF THE PREFERRED EMBODIMENTS

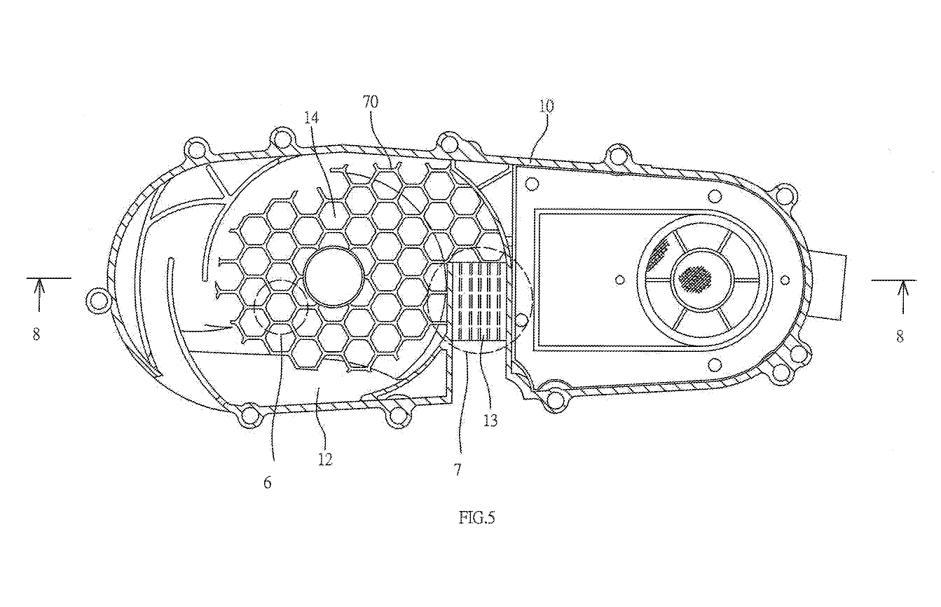

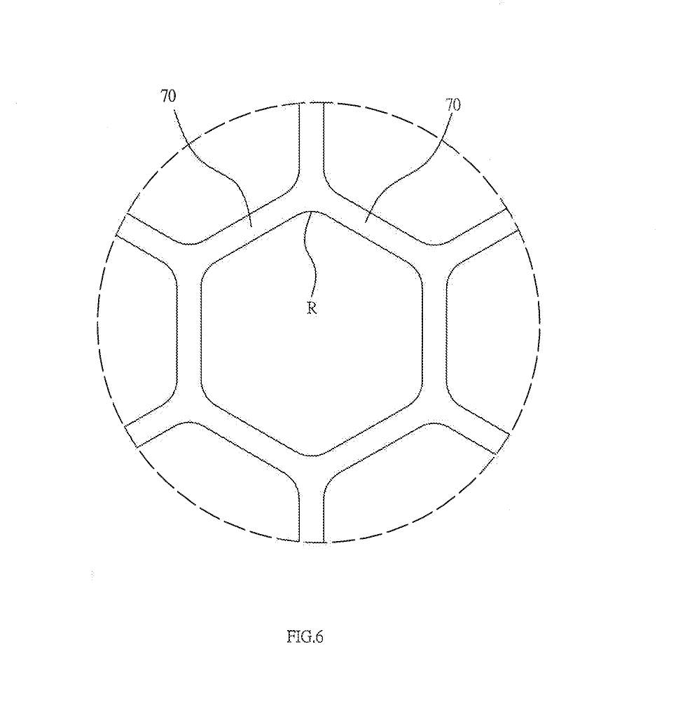

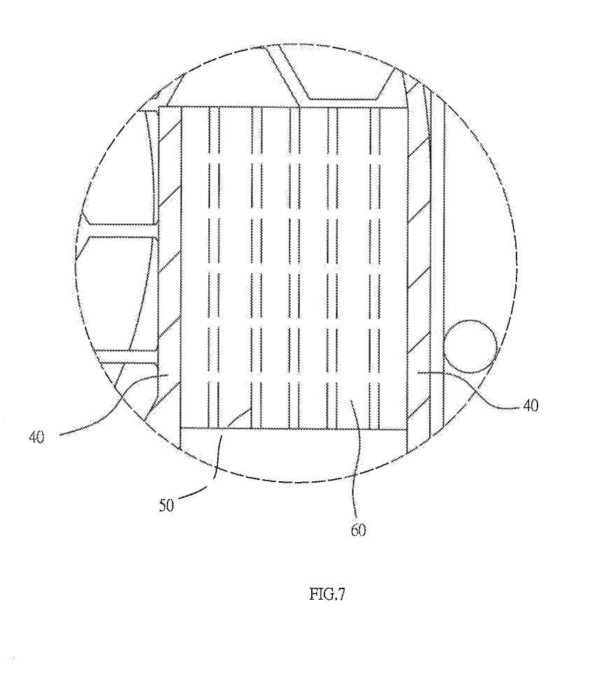

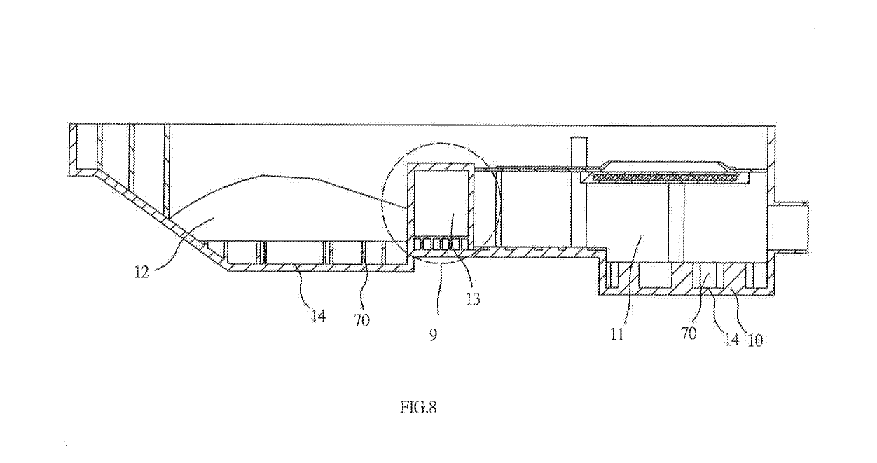

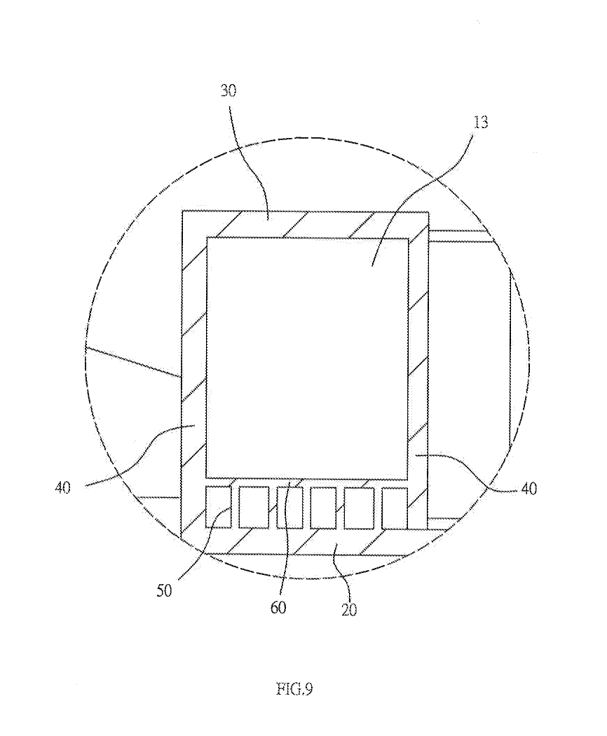

Referring to FIG. 5 to FIG. 9, an engine hood of a motor vehicle according to an embodiment of the present invention includes an air inlet chamber 11, an air outlet chamber 12, and an air outlet channel 13. The air outlet channel 13 is disposed between the air inlet chamber 11 and the air outlet chamber 12, and is formed by an outer cover plate 20, an inner cover plate 30, and two side plates 40 connects to two corresponding lateral sides of the outer cover plate 20 and the inner cover plate 30.

A plurality of ribs 70 are inwardly extended at inner sides 14 of surfaces of the air inlet chamber 11 and the air outlet chamber 12. The ribs 70 are vertically and horizontally staggered in a polygonal arrangement at the inner side 14 of the surface of either the air inlet chamber 11 or the air outlet chamber 12 having a greater surface area. An arched guiding angle R is formed at a junction of every two adjacent ribs 70 of the ribs 70. In the present invention, the term “polygonal” may be triangular, quadrilateral, pentagonal, hexagonal and octagonal. In one embodiment of the present invention, the polygonal arrangement is a hexagonal arrangement.

With the design of the arched guiding angles R, during an injection and molding process of the engine hood 10 of the motor vehicle, the fluidity of resin can be increased to more easily form the engine hood 10 of the motor vehicle. Further, the design of the arched guiding angles R is capable of solving the concentrated stress in the prior art to thus enhance the structural strength of the engine hood 10 of the motor vehicle.

In the embodiment, the outer cover plate 20 refers to a plate of the air outlet channel 13 near an outer side of the engine hood 10 of the motor vehicle, and the inner cover plate 30 refers to a plate of the air outlet channel 13 near an inner side of the engine hood 10 of the motor vehicle. The present invention is characterized that, a reinforcement plate 50 is extended above the outer cover plate 20 towards the inner cover plate 30. An included angle is formed between the reinforcement plate 50 and the outer cover plate 20.

In the embodiment, five reinforcement plates 50 are provided above the outer cover plate 20, and each of the reinforcement plates 50 and the outer cover plate 20 form a perpendicular arrangement to display a 90° included angle between that reinforcement plate 50 and the outer cover plate 20. In practice, the reinforcement plate 50 may also be slantingly extended from the outer cover plate 20 towards the inner cover plate 30 at an angle to form an included angle between the reinforcement plate 50 and the outer cover plate 20, with the included angle being smaller than 90°. The number of the reinforcement plates 50 may be increased or decreased along with the width (i.e., a distance along an extension direction between the two side plates 40) of the outer cover plate 20. That is, the number of reinforcement plates 50 increases as the length of the outer cover plate 20 gets longer, and gets smaller as the length of the outer cover plate 20 gets shorter.

A connecting plate 60 is provided at an end of each reinforcement plate 50, and is parallel with the outer cover plate 20. In the embodiment, the connecting plate 60 is extended between the two side plates 40 and is connected to the side plates 40. Further, a distance between the connecting plate 60 and the outer cover plate 20 is smaller than a distance between the connecting plate 60 and the inner cover plate 30.

Accordingly, with the reinforcement plate 50 extending from above the outer cover plate 20 towards the inner cover plate 30 and the connecting plate 60 at the end of the reinforcement plate 50, the structural strength of the outer cover plate 20 is enhanced. Therefore, when the outer cover plate 20 receives impacts of external forces, certain structural strength is maintained.

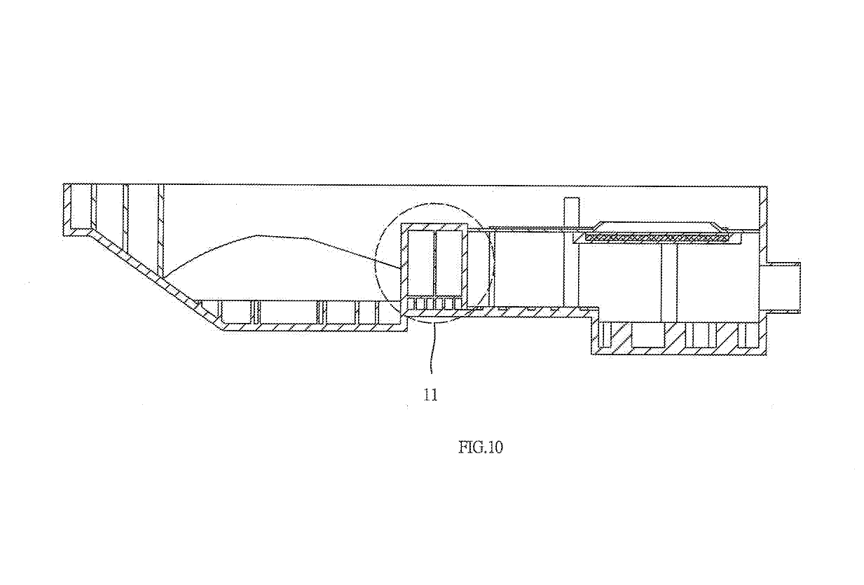

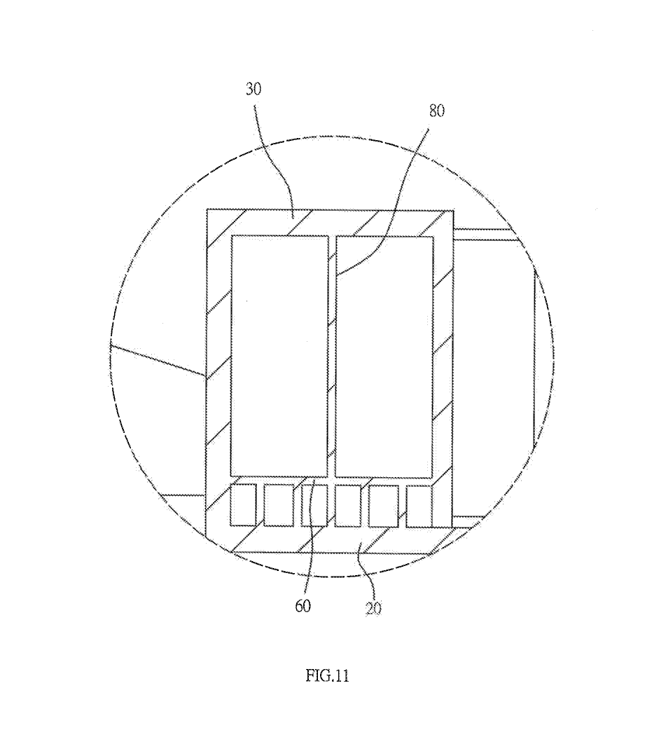

FIG. 10 and FIG. 11 show a second embodiment of the present invention. In the embodiment, a strengthening plate 80 is extended from above the connecting plate 60 towards the inner cover plate 30. Two ends of the strengthening plate 80 are respectively connected to the connecting plate 60 and the inner cover plate 30, so as to utilize support that the strengthening plate 80 generates on the connecting plate 60 to further reinforce the structural strength of the outer cover plate 20.

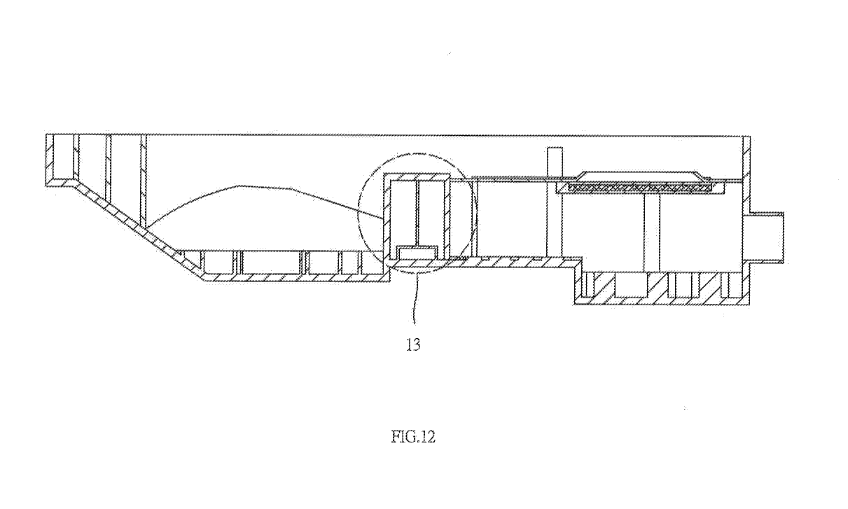

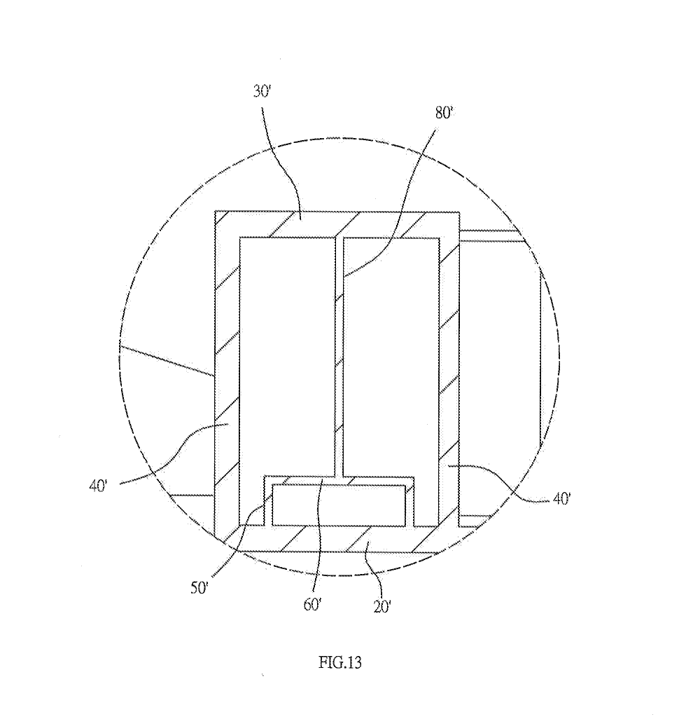

FIG. 12 and FIG. 13 show a third embodiment of the present invention. In the embodiment, two reinforcement plates 50′ are provided above an outer cover plate 20′. Two ends of a connecting plate 60′ are respectively connected to ends of the two reinforcement plates 50′ and are connected to two side plates 40′. A strengthening plate 80′ is similarly disposed between the connecting plate 60′ and an inner cover plate 30′. Thus, an effect of reinforcing the structural strength of the outer cover plate 20′ is also achieved.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

It is of course to be understood that the embodiments described herein are merely illustrative of the principles of the invention and that a wide variety of modifications thereto may be effected by persons skilled in the art without departing from the spirit and scope of the invention as set forth in the following claims,

What is claimed is:

1. A reinforcement structure for an engine hood of a motor vehicle comprising an air inlet chamber, an air outlet chamber, and at least one air outlet channel disposed between the air inlet chamber and the air outlet chamber; the air outlet channel formed by an outer cover plate, an inner cover plate and two side plates respectively connected to respective lateral sides of the outer cover plate and the inner cover plate, wherein
a plurality of ribs are inwardly extended at an inner side of a surface of either the air inlet chamber or the air outlet chamber, the ribs are vertically and horizontally staggered in a polygonal arrangement at the inner side of the surface of either the air inlet chamber or the air outlet chamber, and an arched guiding angle is formed between any two adjacent ribs.

2. The reinforcement structure according to claim 1, wherein the ribs are disposed at the inner side of the surface of either the air inlet chamber or the air outlet chamber having a surface greater area.

3. A reinforcement structure for an engine hood of a motor vehicle comprising an air inlet chamber, an air outlet chamber, and at least one air outlet channel disposed between the air inlet chamber and the air outlet chamber; the air outlet channel formed by an outer cover plate, an inner cover plate and two side plates respectively connected to respective lateral sides of the outer cover plate and the inner cover plate, the reinforcement structure wherein
a plurality of ribs are inwardly extended at inner sides of surfaces of the air inlet chamber and the air outlet chamber, the ribs are vertically and horizontally staggered in a polygonal arrangement at the inner sides of the surfaces of the air inlet chamber and the air outlet chamber, and an arched guiding angle is formed between any two adjacent ribs;
at least one reinforcement plate is extended from above the outer cover plate towards the inner cover plate, an included angle is formed between the reinforcement plate and the outer cover plate, a connecting plate is disposed at an end of the reinforcement plate and is parallel with the outer cover plate, and a distance between the connecting plate and the outer cover plate is smaller than a distance between the connecting plate and the inner cover plate.

4. The reinforcement structure according to claim 3, wherein two ends of the connecting plates are respectively connected to the side plates.

5. The reinforcement structure according to claim 3, wherein a strengthening plate is further disposed between the connecting plate and the inner cover plate, and two ends of the strengthening plate are respectively connected to the connecting plate and the inner cover plate.

6. The reinforcement structure according to claim 3, wherein the reinforcement plate is perpendicular to the outer cover plate, and the included angle between the reinforcement plate and the outer cover plate is 90°.

7. The reinforcement structure according to claim 3, wherein the included angle between the reinforcement plate and the outer cover plate is smaller than 90°.
